(19) United States
(12) Patent Application Publication
(10) Pub. No.: US 2017/0215032 A1
(43) Pub. Date: Jul. 27, 2017

(54) Geotags For Accessing Local Information By The Visually Impaired

(71) Applicant: Mark Horbal, Boca Raton, FL (US)

(72) Inventor: Mark Horbal, Boca Raton, FL (US)

(21) Appl. No.: 15/050,392

(22) Filed: Feb. 22, 2016

Related U.S. Application Data
(60) Provisional application No. 62/286,525, filed on Jan. 25, 2016.

(51) Int. Cl. H04W 4/02

(52) U.S. Cl. CPC H04W 4/02

(57) ABSTRACT

Geotags, installed at fixed locations, communicate location specific information to a Device that uses that information to access additional information, either stored locally or accessed from remote systems. The information provided by the Geotags can be static information, such as addresses, or just unique IDs that can be translated to Internet URL addresses that are used by the Device to obtain dynamic information related to changing situations or allow the user to interact with locations to which the Geotag is affixed. The information is then used by blind individuals to navigate movement in their physical environment. The Geotags may further incorporate optional indicia, such as Braille, on the grid surface to aid a blind user.

### CROSS-REFERENCE TO RELATED APPLICATIONS

This application is related to, and claims the benefit of, the copending provisional patent application entitled “Universal Intelligent Module For Communications, Transactions, and Payments,” filed Jan. 25, 2016, bearing U.S. Ser. No. 62/286,525 and naming Mark Horbal, the named inventor herein, as sole inventor, the contents of which is specifically incorporated by reference herein in its entirety.

### BACKGROUND

Technical Field

This invention relates in general to accessing location specific information by portable electronic devices, with value for the general population and with special value for the visually impaired. In particular, it relates to a novel system for mobile smart devices, such as cellular phones, smart phones, computer tablets, and other portable electronic devices. The invention provides NFC and/or RFID tags (“Geotags”) that are placed in specific geographic locations. A mobile smart device detects the Geotag when it is in proximity to the Geotag, and interprets information from the Geotag that the mobile smart device then uses to access additional information an external data source or network. Those device which do not have built-in NFC readers can be easily equipped with an external NFC reader that mates with the device via its data or audio connector, depending on its type. The Geotags allow information to be provided to anyone with a smart device, but they are especially valuable to visually impaired individuals who require information related to their current location. The invention teaches a method of informing a smart device with location specific information that is used to access additional information about that location that can inform the user of scheduled events related to that location as well as detailed information about the surrounding area. The invention additionally teaches a method of allowing a person, especially a blind person, to interact with the location to which the Geotag is attached, using the smart device.

Background of the Invention

Portable devices are ubiquitous in today's society. “Smart” mobile cell phones available today are becoming pervasive and are increasingly replacing the older phones. In addition to smart cell phones there are many portable intelligent devices, such as tablet computers and portable terminals that have most or even all of the features of the smart telephones, such as GPS, access to Internet, ability to access websites and other remote servers and applications. For ease of discussion, smart cell phones, tablets and like devices will be referred to as “Devices.” Likewise, the term “Blind” will be used to refer to both legally blind and visually impaired individuals.

In recent times, mobile device covers or cases have been designed to contain additional batteries. Such covers or cases also include a connector that mates with the mobile device when such cover or case is used. Also, there exist a number of devices, which when mated with the mobile device via its digital interface or its audio input. An example of the latter is a magnetic credit card readers used for credit card authorization and payment via the mobile device.

Today, Devices have sufficient processing strength to support many useful features, such GPS location support, Internet access, telephony, audio output, text-to-voice output, voice input, voice recognition, and numerous software applications. Unfortunately, current Devices present a significant disadvantage to the Blind. In particular, portable Devices typically use touch panel displays without any mechanical data entry buttons or keyboards. Instead, they display icons on the touch panel display that represent the various functions provided by the Device. Of course, the Blind will find this type of input system very difficult, if not impossible, to use.

Today, Devices can be equipped with many applications and/or access to websites and external services that are potentially extremely useful to Blind individuals. Because of their inherent complexity, modern Devices typically employ a touch screen as the primary interface between the user and the device. The touch screen interface is used (a) to select and initiate the operation of an App resident on the Device or on a remote website, (b) to interact with the said App or Website, and (c) to configure and control the device itself. A traditional touch screen paradigm involves the use of a number of different context-sensitive screens. For example, in its normal (rest) state, the device typically displays a menu of available Apps and/or websites and allows an app to be started or a webpage to be displayed. In some cases, these Apps or web pages have been accessed earlier and the menu simply switches the context to the previously started App or previously accessed web page. Once the context is switched to the App or web page, the touch screen interface is used to interact with the App or web page in order to perform the desired functions. The interface can also be used to return to the main menu or switch to another App or web page.

Although intuitive and easy to use for most people, the touch screen user interface is very challenging for the Blind for a number of reasons: (a) the App/Web elements are typically displayed as icons that cannot be seen by the Blind, (b) physical interaction with the touch screen is accomplished by a precise visually guided touch by the user, a task impossible for the Blind, (c) even if learned, the position of screen icons can change by reconfiguration or updates to the Apps or the operating system of the device, and (d) although the Devices themselves typically adhere to a consistent positioning of icons used to start/enter Apps and web pages from the menu, these standards are typically not followed by the Apps or web pages themselves, once started or entered. Furthermore, even if a Blind person wants to use a simple application, such as making a telephone call, it can be difficult even if the keys are located in the same place. In addition, since Device touch screen sizes can vary from one model to another, migration to a new Device may require practice and learning by the Blind before the key locations for a simple phone call are learned. Of course, most Apps have icons that are not fixed like a telephone keypad, and as a result, they may not be usable by the Blind. As a result, while many useful Devices are taken for granted by the sighted, often cannot be used by the Blind. It would be desirable to have Devices that the Blind can conveniently control such that they can take advantage of the many useful features that the Devices offer.

However, a drawback related to such covers is that even if Devices are made such that a blind user can easily locate entry points on the Device's touch panel screen, it fails to provide information related to the physical surroundings the blind person is in, or provide any information related to events that are related the that particular physical location. However, Devices that only assist a blind individual in operating a Device solve one type of problem experienced by the Blind. Another problem that blind individuals have is that they do not have information that is readily available to sighted individuals in public places. For example, when a blind individual passes by a building, he would not have any way of knowing the address, the businesses located in the building. Likewise, blind individuals would have no way of knowing if they were at a public transportation stop, when the next transit vehicle was due to arrive, or at other public venues. It would be desirable to extend the features of Devices such that they can assist an individual in locating and navigating through public places.

While the prior art has provided a variety of high function Devices for the sighted, it has failed to provide Devices that can also be used by the Blind. It would be desirable to extend the features and advantages of these Devices to the Blind such that the blind could more easily travel, find locations, and be informed of events in that area. It would be further desirable to have geographic location information available through a Device such that a blind individual could navigate their way through public areas without assistance from others and possibly interact with a variety of systems designed primarily for the sighted, such as elevators, vending machines, ticketing systems and others.

### SUMMARY OF THE INVENTION

This invention provides Geotags that communicate location specific information to a Device that uses that information to access additional information, either stored locally or accessed from remote systems. The information provided by the Geotags is preferably a unique ID which allows the Geotag to be produced very inexpensively. Optionally, the Geotag can be structured to provide additional information, that can be static information, such as addresses, or dynamic information such as Internet URL addresses that are used by the Device to obtain information related to changing situations, and to then provide that information to a user.

### BRIEF DESCRIPTION OF THE DRAWINGS

FIG. 1 illustrates a prior art cell phone encased in a prior art protective cover.

FIG. 2 illustrates a front view of a prior art assistive grid.

FIG. 3 illustrates a front view of a prior art assistive grid that has optional Braille markings to assist a blind individual when learning to use, and then using, the assistive grid.

FIG. 4 is a prior art illustration that shows the timing used by the gesture function.

FIGS. 5-8 illustrate Geotags having a variety of different distinctive shapes.

FIG. 5 illustrates a preferred embodiment of the invention in which the Geotag is enclosed in a star shaped container and includes an optional Braille panel attached for the convenience of a blind person.

FIG. 6 illustrates a preferred embodiment of the invention in which the Geotag is enclosed in a triangle shaped container. It also has an optional Braille panel attached for the convenience of a blind person.

FIG. 7 illustrates a preferred embodiment of the invention in which the Geotag is enclosed in a pyramid shaped container. It also has an optional Braille panel attached for the convenience of a blind person.

FIG. 8 illustrates a preferred embodiment of the invention in which the Geotag is enclosed in a Circular shaped container. It also shows an optional Braille panel attached for the convenience of a blind person. In addition, the container is shaped for attachment to a post or similar item, and further has an adjustable attachment strap.

FIG. 9 is a flowchart showing the steps involved with initial installation and setup of a Geotag.

FIG. 10 is a flowchart showing the steps taken during normal operation.

### DETAILED DESCRIPTION OF THE PREFERRED EMBODIMENT

The preferred embodiment uses Geotags that are broadly distributed across geographic locations. The Geotags provide information related to the specific location they are in, and communicate with a user's Device when the user is in proximity to the Geotag.

In the preferred embodiment, a Geotag consists of a (i) passive RFID or NFC circuit containing a unique ID, (ii) encapsulated in a case or package and (iii) equipped with a means of attaching the Geotag to a building or other structure such as a door, the interior of an elevator, exterior of a vending machine, a bus stop or rail station post, etc.

While the shape and external appearance of a Geotag are not necessarily important to a sighted individual, they are very important to a blind individual. Their unique shape still allows the device to be visually recognized by normally sighted people, but also allows the device to be detected by palpation by those who are blind or visually handicapped. In the preferred embodiment, multiple shapes are used. For example, one shape may be selected to indicate a bus stop, another shape to indicate a building entrance, Etc.

In addition to the shape of the Geotag, the location and position where Geotags are mounted should adhere to a standard, so they may be easily located, especially for blind individuals. For example, building floors are typically printed or otherwise indicated on the frame of the elevator doors, the position of Braille markings for elevator buttons is standardized as well. There are many other examples, such as the street crossing warnings using truncated spheres (“warning dots”) at intersections, in order to facilitate pedestrian safety for the blind. By having a standard location and position of the Geotag, a blind individual will have much greater ease of locating and using the Geotag. Similarly, the Geotag's standard shape will confirm to a blind person that they have located a Geotag capable of providing local information and even interaction.

In many applications, Geotags will be used outdoors where it will be subject to any number of environmental conditions. As a result, the preferred embodiment of the Geotag is an environmentally sealed device that will prevent contamination of the Geotag by rainwater, moisture, humidity, dust, insects, etc. Another factor associated with any device, even a sealed device, is that it should be securely help in place, especially in outdoor environments where the environment may cause the Geotag to become disconnected. The means of attachment of a Geotag to a building structure, post, vending machine or other structure can vary, depending on the properties of the structure to which the Geotag is attached, And the environment in which will be used (e.g., outdoors, indoors, etc.). For example, the means of attachment can be an appropriate adhesive; an eye through which a screw fastener is passed, a clamp, such as may be used to attach the Geotag to a post or any other suitable means. By way of example, one possible embodiment of a Geotag is a conspicuously shaped plastic, resin, or epoxy object with a mechanically embedded and thus environmentally sealed RFID/NFC tag and a means of attachment, such as an adhesive pad, a fastener hole or a clamp. In general, attachment of a Geotag should be both simple and secure.

Once the Geotag is in place, it provides appropriate location specific information to any Device that comes within range. The information may take the form of static information, such as and address of the building, or the name of the company with in that building. In the preferred embodiment, the Geotag may also provide the device with the ability to access dynamic information. For example, the Geotag may provide the Device with an address of the website that the Device can then use the address to access the website and interact with it. One example of dynamic information would be to use the website address to access a remote computer that monitors bus schedules and locations of buses. A sight impaired individual could then use the Device to find out what bus stop the user is currently standing at, when the next buses are due to arrive, which lines that each of the buses are on, and even allow the individual to contact the bus driver so that he knows a blind individual is waiting at a specific stop.

When the Device using information obtained from the Geotag to access a remote website, the preferred embodiment envisages the following steps. In general, a particular Geotag must correspond to a particular website or a particular page of a particular website, so that when a Geotag is read by a mobile device, such as a mobile telephone or tablet, the user's mobile Device's browser is directed to that website or a particular web page of that website. It is that website or that page of the website that provides the desired local information.

An example of how the Device would interact with the Geotag and a remote system would be as follows.

1. In the preferred embodiment, the Geotags are mapped such that their location is known to the system. Each Geotag must be registered with a central authority or “registry” once it is secured to a location. The process must be properly authenticated in order to prevent misuse of the device and its associated web page. Part of the registration process can additionally include the GPS coordinates of the location at which the Geotag is located, in order to improve the security of its subsequent use.

2. When a Device comes within proximity of the Geotag, it activates the previously dormant Geotag with an electromagnetic field. This happens automatically when the Device is brought into close proximity with a passive Geotag. This step is unnecessary if the Geotag is active (i.e., powered by an external source), in which case proximity between the Geotag and the Device is unnecessary. In this case, the Geotag continually transmits it's information, without having to sense the presence of the smart device

3. Once activated, the Geotag transmits its ID to an application in the Device.

4. The application then makes a request to the registry service sending the Geotag ID.

5. When the Registry service receives the Geo tag ID it returns the website or webpage URL (Uniform Resource Locator) corresponding to the Geotag's ID, as predetermined during the registration process. Examples of such URL's are:

a) http://www.474lakeshoredrive.com/elevator6

b) https://www.chicagotrafficlights.com/56af015

c) https://www.moma.org/exhibits/678

6. The URL is used by the Device's browser to access the website or webpage as provided by the registry service so that the user may access local information corresponding to the Geotag.

7. If the interaction with the website or web page involves interaction with a device or system such as an elevator, traffic light, metro transportation system, etc., than the Device is further enhanced by a Grid that overlays the touch screen of the Device in a manner that allows Blind users to easily locate and touch standard locations on the device screen. Information from the Geotags is input to Apps running on the Device or Internet websites and web pages accessed by the Device to provide location dependent information, time dependent information, and or dynamic scheduling information to the individual.

The Geotags work in concert with the Grid to provide a standardized method of interacting with the Device by a Blind user that is both intuitive, easy to learn and use, and conceptually portable across a multitude of Apps and websites. Finally, the invention teaches a number of “Gestures” that enhance the use of the interface by the Blind. Gestures are methods employed in physically interacting with the touch screen and normally employed by the Devices. Common gestures employed by users to interact with device touch screens include tap, swipe, pinch, scroll, rotate and many others. The gestures taught by this invention are inherently simpler and intended for the blind user. Optionally, the Grid can incorporate raised indicia, such as Braille, on the Grid surface to aid a Blind user when learning how to use a given Device. The Geotags enhance the use of the device by providing location information as well as dynamically changing information, such a public transportation arrival times.

The Geotags are also designed with uniquely shaped covers that allow a blind user to identify it as a Geotag by touch. The different shapes used by the Geotags can also inform a blind individual about the type of information it provides. For example, a selected Geotag shape may indicate that it holds the address of the building it is located on. Another shape may indicate that it provides information about events near the Geotag, as well as its location. For example, the Geotag may provide information to a blind individual that the individual is at a bus stop, and also provide information to the individual's Device, such as a web address, that the Device can use to access schedules and the time remaining until the next bus arrives.

The Geotag can be implemented with RFID tags, NFC tags, or any other equivalent technology, so long as the Geotag can communicate with the Device. NFC tags can be used to provide inexpensive access to very local information without additional technology. In ease of discussion, the term NFC means Near Field Communication, and the term RFID means Radio Frequency Identification. Those skilled in the art will realize that while the preferred embodiments use passive RFID or NFC tags, active tags can also be used to increase range, although such increased range is not always useful. A passive tag is an electronic device that is able to transmit its ID when illuminated by an external radio wave field, which powers it. Usually, such field is provided by the reader, which both powers the passive tag by transmitting a radio wave field and then receives the ID transmitted by the tag. Once the powering field is removed, the tag loses power and deactivates.

By way of example, when a user wants event information, the user can take advantage of a passive RFID/NFC tag is attached to a physical location, in this case, a bus stop post. The tag is fabricated with a unique shape that makes it easily recognizable as a “Geotag” with touched by a blind individual. General attributes of a Geotag include:

1. A Geotag has a passive RFID or NFC device enclosed within a casing, and a means for stationary mounting.

2. A Geotag may be powered by an external power source.

3. A Geotag has casing preferably has a conspicuous appearance, including a conspicuous shape, color or markings, so that it may be easily recognized by sighted individuals and recognized via palpation by blind individuals.

4. A Geotag may have a casing that includes Braille markings identifying the device as a Geotag.

5. A Geotag may include a mechanism yielding the device inoperative if removed after being mounted.

6. A Geotag has a unique ID that is communicated to a registry service that allows the ID provided by a Geotag to map to a website or a web page corresponding to that Geotag.

7. The registry service additionally stores the GPS coordinates of the Geotags during the installation process so that it can verify when a request containing the Geotag ID is made from a location corresponding to the Geotag's GPS coordinates.

8. The registry service preferably uses an SSL/TLS certificate that verifies its authenticity to the Device application, which sends the Geotag ID.

9. The Geotag has a unique ID that allows the registration process to associate a particular Geotag with a website or a web page corresponding to that Geotag by the registry service.

10. A website or a web page that provides information corresponding to a particular Geotag, or allows interaction with the Device, appliance, or system to which the particular Geotag is attached.

11. A Device application which receives the ID from the Geotag and uses it to retrieve the website or webpage URL from the registry service and provide that information to the Device's browser.

12. Verification of the location of a Geotag by comparing it's registered location to that obtained by methods other than GPS, such as triangulation based on the strength of mobile telephony signals and local Wi-Fi sources.

13. An optional externally powered Announcement Geotag, which continuously transmits its ID, allowing the Device application to inform the user of arrival into a particular area.

14. An optional Announcement Geotag equipped with a directional baffle that limits its radiation pattern so that the ID can only be received in well-defined areas.

15. A website or web page accessed by the Device, via the URL provided by the registry service, that provides audio cues and information that are easily understood by the blind.

In addition, the Geotags provided by the invention are fixed location devices that provide location information, or nearby event information to mobile Devices when the Geotags are activated by the mobile Devices.

The Device which powers the Geotag with a an electromagnetic field, receives the ID, and interrogates the registry service for the URL, may be a mobile phone, tablet, or other device, that is capable of using an RFID or NFC reader device that is attached to it

A person touches or comes close to the Geotag with his Device (e.g. a phone equipped with an integral NFC reader or an externally connected NFC reader device) causing the Geotag to power up. This allows the Device to receive the Geotag's id. This id is then used by the software contained in the Device to access an associated website, via the Device's resident browser, that corresponds to this particular bus stop. In addition, the Geotag could also directly supply the website address to the Device. The website, in turn, can now provide the user local information corresponding to this particular bus stop. For example, the route numbers that stop at this bus stop, the time of arrival of the next bus and its route number, etc.

In addition to event information, Geotags can also provide local information. Local information is typically limited in scope and is highly relevant to a location. Examples of such “locations” and the associated “local information” may be A) Static Information such as the building's address; B) Dynamic Information, such as a time of day, next bus number arriving at a bus stop, the current floor that the elevator is on, etc. In addition, the local information can be bi-directional and interactive, for example, a user can interact with a website corresponding to a particular bus stop to inform to the drivers that that the bus should stop. Other types of information provided by the Geotags can be:

| Location | Local Information |
|---|---|
| Office building | Building directory (static or dynamic) |
| entry | Emergency locations and services (static) |
| | Alert (e.g. ring doorbell of) a selected tenant. |
| Elevator | Which floors the elevator services (static) |
| | Current elevator location/direction e.g. 12^{th} floor/UP |
| | (dynamic) |
| | User enters floor number (interactive) |
| Museum | Description of displayed object (static) |
| | Narrative (static) |
| Vending machine | Items vended and respective prices (static) |
| | User places order (interactive) |
| | Mobile Payment (interactive) |
| Bus Stop | Route information (static) |
| | Approximate wait time (dynamic) |
| | Payment capability (interactive) |
| On public | Bus/train/line description (static or dynamic) |
| transportation | Destination/direction (dynamic) |
| | Next stop (dynamic) |
| | Payment capability (interactive) |
| Street signs | Location (static) |
| Traffic light | Location (static) |
| signs | Light state, time to yellow or “Don't Walk” (dynamic) |
| | Request to cross (interactive) |
| | Remaining duration of green/safe light (dynamic) |
| | Request for assistance |
| Parking Meter | Remaining time for payer (static) |
| | Payment (interactive) |
| Automatic Teller | Check balance (dynamic) |
| Machine | Login, Retrieve cash, Transfer funds between accounts |
| | (interactive) |
| Diagnostic port | Car/device/etc. status, error codes (dynamic) |
| in car, appliance, | Access to instruction, service manuals (static) |
| etc. | Changing device settings (interactive) |

The invention provides a number of benefits that are not limited solely to blind individuals, but also provides a number of benefits to the general public. For example, the invention provides a convenient means of rapidly gaining access to local information such as when an individual interacts with a Geotag-equipped bus stop or using the Geotag to hear a narrative about a particular exhibit in a museum. The invention also provides a benefit in that it allows devices, appliances, parking meters, etc. to have an equivalent of a user interface, without burdening the cost of the device with the cost of a user interface, which frequently involves displays, pushbuttons etc., especially if the devices need to be weatherproof. Yet another benefit is that the cost of a Geotag is exceptionally low. In quantities, RFID/NFC Geotags cost less than a dollar. Even with the additional cost of encapsulation and mounting/attachment provisions, the cost is very low. This allows a wide range of functionality to be provided with minimal cost.

Another embodiment of the invention uses “Announcement Geotags.” Announcement Geotags are similar to the other Geotags disclosed herein except that Announcement Geotags are externally powered and thus transmit their ID continuously, thus not requiring proximity to the mobile device. Once the Geotag's ID is received by the Device, the registry service is queried and the Device's browser accesses the website in the usual manner, allowing the associated website to stream an audio announcement messages such as “You are now on track 6,” “Train 475 bound for Geneva leaves at 3 PM,” or “This elevator services floors 1 through 20.” While this embodiment has limited utility for the sighted, the blind will find it very useful and valuable.

While Geotags provide benefits to everyone, they are of special value to those who are blind or visually handicapped. They can be easily deployed in building interiors, elevators, street crossing, public transportation stops, on vending machines and in a vast number of other locations where local information is needed but not generally available to the visually handicapped. Consider the benefit of installing Geotags in each of an office building's elevators, allowing the blind to use their mobile devices to select their destination floor and to know when they arrive there. Consider also, the benefit of installing Geotags on buses, in order to allow blind people not only to confirm that they are boarding the correct bus, to select their destination stop, track the bus' progress and be informed when they arrive at their destination. Yet another Geotag benefit is the mapping of interior spaces, allowing blind users to determine their location in a building as well as identify and interact with Geotag-equipped vending and automatic teller machines and many others.

Of course, the above applications and the benefits they provide require a pervasive deployment of Geotags. However, the extremely low price of a Geotag makes this possible and practical.

The foregoing examples summarize the essence of this invention. The important elements include A) a passive (and in some cases active) RFID/NFC Geotags permanently attached to physical locations; B) A Device capable of reading RFID/NFC Geotags and having a browser capable of accessing websites providing local information corresponding to the particular Geotag: and C) a Device that uses the Geotag's id, or information transmitted by the Geotag to access a website that provides the above local information to the user.

The preferred embodiment of the invention also includes security measures to prevent misuse of the invention such as (i) relocation of the Geotag to a different location after it's location and function has been registered with the registry service, (ii) interjection of a false registry service that can provide incorrect website or webpage information to the requesting mobile device, or (iii) tampering with the Geotag itself.

Since Geotags are located in public areas with easy access to them by the public, it is important to protect them from unauthorized tampering. When a Geotag this installed, it's ID and the corresponding website or web page information must be registered with a registry service in order for the latter to service ID lookup requests. During this same process, the GPS coordinates of the Geotag are registered with the registry service. Once the Geotag is successfully registered, when a Device reads the Geotag's ID, the Device's application sends the ID along with the GPS coordinates of the Device itself, as provided by the Device's GPS mechanism, to the registry service. Upon receiving the request from the mobile device, the registry compares the provided GPS coordinates with the coordinates of the Geotag, as stored in it's database, validating the request if such coordinates are within a reasonable and expected distance of each other. Otherwise, an appropriate error is returned to the requesting Device. As can be seen, this simple procedure prevents misuse based on unauthorized relocation of a Geotag.

The registry is configured with an SSL (Secure Sockets Layer) or TLS (Transport Layer Security) certificate that authenticates the registry service to the requesting mobile device application, similarly to a bank website SSL/TLS certificate verifying its authenticity. SSL and TLS certificates are well known in the art. In addition, the presence of the SSL/TLS certificate on the registry service website allows the request/response communication between the mobile app and the registry service to be encrypted, preventing man-in-the-middle cyber attacks. The security measures described here also protect the initial Geotag registration process.

The Geotag can also include a means for rendering it inoperative when removed after the initial installation or when tampered with. For example, the Geotag constructed such that if it is opened, the RFID or NFC chip will be damaged and become inoperable. This security feature, if used, further prevents misuse of the Geotag.

Finally, while generally useful to the public at large, the invention is especially helpful to those who are blind or visually handicapped. In order for such usefulness to be maximized, the website or web pages accessed via the mechanism described herein should preferably provide audio information and display/position their interactive buttons in a well organized and ideally standardized way, in order to maximize their usability by the blind.

Having discussed the features and advantages of the invention in general. We turn now to a discussion of the figures.

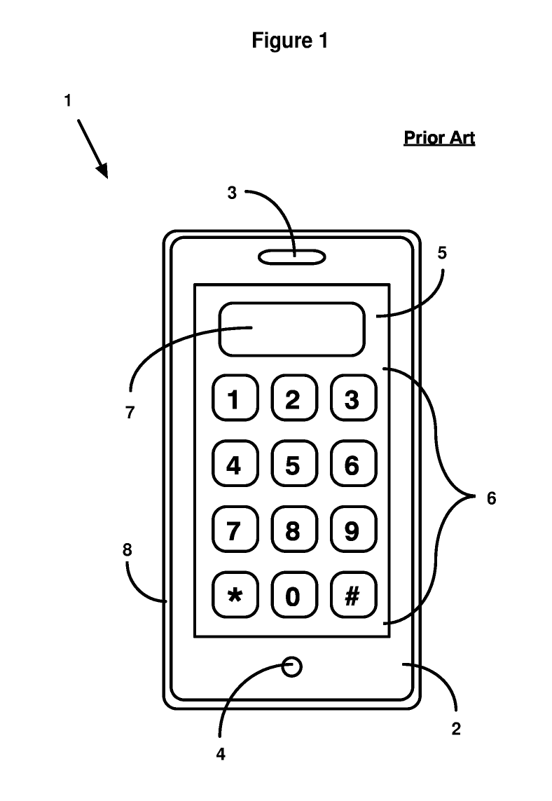

FIG. 1 illustrates a prior art cell phone 1 encased in a prior art protective cover 8. While a cell phone is used for illustrative purposes, those skilled in the art will recognize that the same configuration can be used for any number of intelligent portable devices 1, such as tablet computers (e.g. iPad™, iPod™, Microsoft Surface™ tablet, etc.), portable terminals, etc. Modern cell phones, especially smart phones, typically do no have mechanical keypads for data entry. Instead, flat touch panel displays have become the norm. Likewise, for ease of discussion, the invention is discussed in terms of a protective cover 8, but those skilled in the art will recognize that the grid 9 does not have to be integrated with a protective cover, and can be implemented solely as a grid 9 that defines the locations of data entry locations on a touch screen.

The prior art cell phone 1 that is used as an example in this figure typically has a body 2 that contains a speaker 3, a microphone 4, and a display panel 5. The display panel 5 is a touch panel display that allows a user to enter data for any application the smart device is used for. Typically, applications used by intelligent devices may change the information and/or icons displayed on the display panel 5. Even simple application, such as voice telephone calls, many devices have variations in the size and location of the telephone keypad from one model to another due to screen size.

Also shown in this figure are the informational display section 7 of the display panel 5 which typically would display information such as the number being dialed for outgoing calls, the caller ID of incoming calls, text messages, etc. While not a standard component of a typical device, many individuals use add-on protective covers 8. The protective cover 8 provides an improved gripping surface, as well as some impact protection in the event the device is inadvertently dropped.

While prior art devices, such as the one discussed above, provide great convenience and usability to sighted individuals, they also present substantial obstacles to the blind. Due to the flat, smooth nature of touch panel displays, a blind individual can never be certain that they have touched the display panel 5 at the proper location. As a result, incorrect phone numbers can be dialed, incorrect application data selections cane be made, etc. If an individual uses a new device, the location of the data entry points (keys) on the display panel 5 may not be the same. Likewise, as cell phone screen sizes change, the size and location of the keys will change. All of these factors have little effect on the sighted, but have very substantial effects on the blind. However, providing an improved physical interface between a blind person and a Device has great benefit, it does not provide a solution for the blind in terms of notifying a blind person when the person is at a particular physical location, or informing a blind person as to dynamic events related to the surroundings, such as bus schedules. The Geotags 14 provided by this invention enhance and improve the ability of a blind individual over and above the benefits provided by the Grid 9.

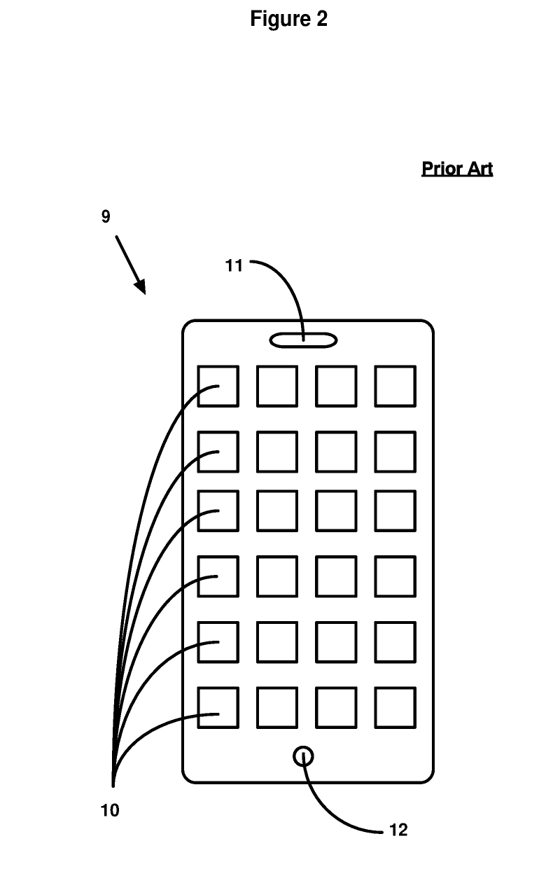

FIG. 2 illustrates a front view of the front surface of a preferred embodiment of the assistive grid 9. The grid 9 has a speaker aperture 11 that overlays the speaker 3, and a microphone aperture that overlays the microphone 4. Appropriate apertures for standard connectors, such as power and audio output are provided as well. A preselected number of icon apertures 10 are located on the grid 9 and are positioned to allow access to icons displayed on the display panel 5. When attached to a device 1, the icon apertures 10 allow a blind individual to know precisely where the input locations are on the display panel 5. As a result, the blind individual can make phone calls to the correct number, or can select other applications without making errors. In addition, the grid 9 helps in a) selecting the correct device-resident apps or external websites, b) correctly interacting with such device-resident apps or external websites, and c) interacting with the device itself, in order to change settings, etc.

The assistive grid 9 has multiple embodiments, because it can be used with a variety of devices that each having their own shape, size, and configuration. For example, the grid 9 can be configured as a snap-on case into which the device is placed such that the grid 9 is positioned and aligned with the device's display panel 5. It can be configured as part of a case that covers the entire device. It can be configured as grid 9 that is secured to the display panel 5 with and adhesive that secures it to the device via double stick tape, adhesive, etc. Likewise, the grid 9 can be hinged to the device case. Any suitable means of attachment of the grid 9 to the device can be used, including adhesives, magnets, and fasteners such as screws or those in which the grid 9 is an integral component of the device itself. If the grid 9 is fabricated from flexible material such as rubberized material, it can easily be secured the device by sliding the device into the grid 9. In this configuration, the grid 9 provides an additional advantage by providing protection against damage that may occur if the device is inadvertently impacted.

The grid 9 is preferably equipped with number of icon apertures 10 in standard locations and with standard spacing corresponding to the position of active touch areas on the display panel 5 that are used to activate applications resident on the device and/or to interact with remote applications on the Internet or other remote systems. The icon apertures 10 can define the location of input areas for telephone functions (e.g., the keypad, and caller ID display, etc.), and also for other icon locations that are used to select any one of a variety of applications.

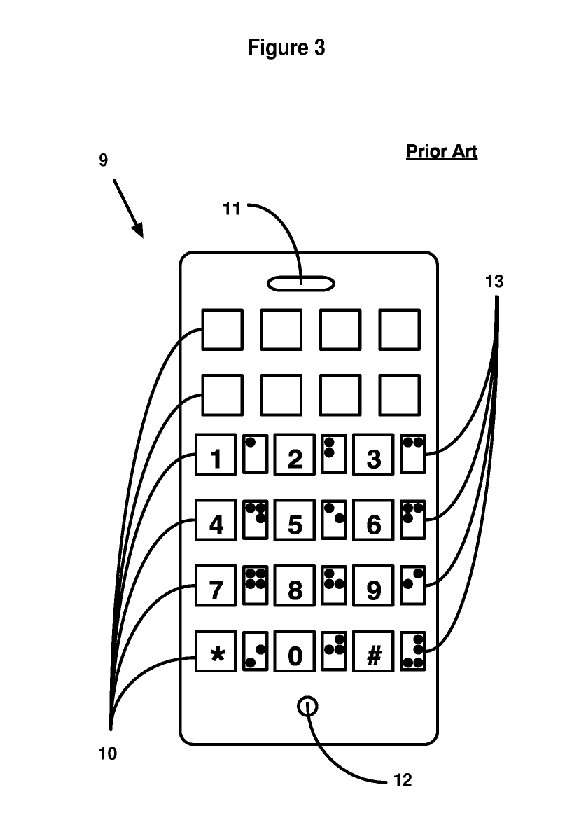

FIG. 3 illustrates a front view of a preferred embodiment of the invention that has optional Braille symbols 13 and/or possibly other symbols to assist a blind individual when learning to use the assistive grid 9. Those skilled in the art will recognize that the Braille symbols 13 can vary in size and be located in any convenient location near their associated icon apertures 10. This figure shows the grid 9 mounted on a device such that the icon apertures 10 expose the icons displayed on the device's display panel 5. In this case, the icons represent the numbers on a telephone keypad. Adjacent each icon is the Braille symbol 13 that represents the keypad number. Having the convenience of the Braille symbol is a useful aid for blind individuals who are just learning how to use the device. In addition, the Braille markings can continue to be useful even after the user is familiar with the grid 9.

Of course, proper alignment of the grid 9 with the device is important for the invention to work properly. One preferred method of alignment is to mold the grid 9 in the form of a sleeve, fabricated from any suitable pliant rubber-like material, into which the device is inserted. This allows the device to automatically align with the icons on the display panel 5 and simultaneously provides a protective cover for the device. However, since there are numerous other applications in addition to the basic telephone function, the arrangement of icons can vary from one application to another. In order for the grid to be used, there must exist a system of aligning the position and size of the icons displayed on the device's screen to the position and size of the grid apertures. While current devices, such as mobile phones, already provide a somewhat standardized icon layout, the layouts cannot be considered as sufficiently standardized to always work reliably with grid. In order to ensure correct alignment, the device should provide a means of configuring its display in order to ensure alignment of the displayed icons with the geometry of the grid 9.

While icons of built-in functions of a device are relatively easy to align, the alignment with the icons of the multitude of online applications is more difficult. Much of today's content is delivered to users via Internet websites. Once such websites are accessed via the device's browser, alignment can no longer be assured. Via standardization of website versions for the visually impaired. Although the W3 standard provides guidelines for improvement of accessibility to websites by handicapped individuals, the current standard is not sufficiently detailed to provide a comprehensive mechanism for interaction with handicapped individuals and especially those visually impaired. Therefore, this invention teaches means for accomplishing this, as follows:

Once the website is notified by the device that it is used by a browser used by the visually impaired, the alternative website provides alternative website pages for visually impaired individuals. The website uses:

Interactive Website Standardization.

Standardization of the placement and size of interaction points (buttons etc.) on such pages in a manner that is consistent with the geometry of the assistive grid 9, so that such pages can be used by the visually impaired.

Standardization Includes Geometry and Function.

Standardization includes consistency of placement of the web page's point of interaction (buttons, etc.) in consistent positions relative to the page itself and in relation to each other. For example, buttons with functions such as “Information About This Page”, “Help”, “Submit” etc. should be positioned to provide maximum portability of the handicapped user's learning curve from one application or web page to another.

Non-Interactive Website Standardization.

The Device's browser to be configured to send information to the website being accessed that describes the configuration of the particular assistive grid 9 being used so that the website can display its pages in a manner that is consistent with the geometry of the assistive grid 9. For example, the display panel sizes can vary widely from one manufacturer to another, and as a result, icon sizes and locations will vary. This requires that the device inform the website application, during initial engagement, of the particular device's configuration.

Browser/Client-Side Page HTML Rewriting.

The device's browser to be configured to “rewrite” the HTML delivered by the website so that the web page interaction points (buttons etc.) are displayed in positions consistent with the geometry of the assistive grid 9.

User Agent.

The User Agent information in the HTTP request header identifying the User's/Device's browser is extended to include the configuration of the assistive grid 9, or alternatively, the creation of an additional information field in the HTTP request for this purpose. Likewise, an extension to include a user's special needs is an additional information field that can be added in the HTTP request.

Audio Help.

Similar to the HTML button formation attribute, above, a new attribute is added to the button to provide a URL to an audio file containing help information that he user can play to explain the function and use of the button. A resident library of audio help files can also be provided to assist users having difficulty when learning the device.

Another feature if the invention is the use of Assistive Gestures in applications resident on the device as well as the device's browser. For example, a long tap (tap and hold) of the button through an aperture of the can simply provide audio help (see Audio Help above). Likewise, a short tap actually performs the corresponding action or causes a submit action if in the browser. The combination of these two gestures is both helpful and intuitive to a visually impaired user. If the button is initially held down for a longer period, after which the audio help is provided. Subsequently, a short tap in the same place actually performs the action, if desired. Else, the gestures can be performed using a different button, until the correct one is located.

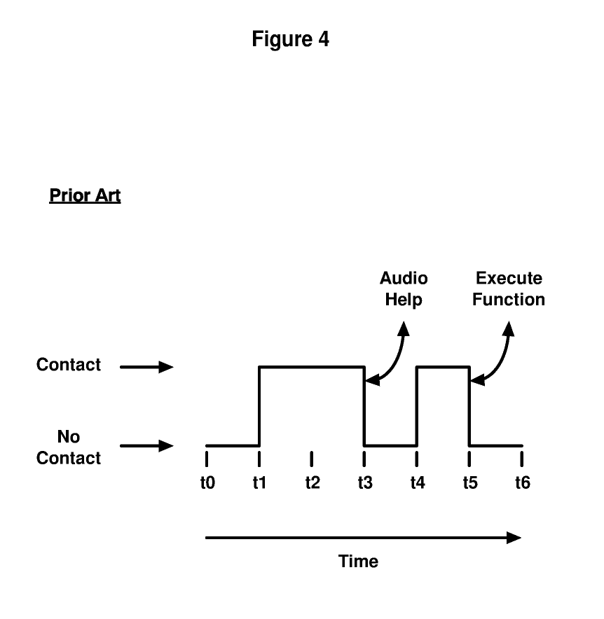

FIG. 4 illustrates how a gesture works. At time t0, the user is not making contact with the display panel 5, and the device is at rest. At time t1, the user contacts touch panel 5 and maintains contact until time t3. At initial contact at t1, the device begins measuring the length of the contact. When the device determines that the contact has been maintained for an extended period, until time t3, the device determines that a request for help is being made. As a result, at time t3, the device activates either an internal audio help process, or an external request for audio help from an Internet URL. On the other hand, if help is not needed, then the user merely taps on the display panel 5 rather than maintaining contact. This is shown at time t4, where the user only maintains contact through time t5. The device determines, based on the short contact, that there is a request to execute the selected function.

The invention provides a number of benefits. The assistive grid 9, which is physically overlaid over the touch screen of mobile devices, such as mobile phones, has a plurality of aperture positions and sizes to further assist in interaction by individuals with various levels of visual handicaps. Depending on the device and application being used, the grid geometry can vary. For example, it could have icon apertures 10 arranged in 6 rows×4 columns, 4 rows×3 columns or a different configuration. The correct icon layout on the device's touch panel 5 can be assured by appropriately configuring the device via its settings, reflecting different grid aperture configurations, and also communicating those settings to the application on the website URL that is being used. Communication with the remote website allows the website to know the configuration of the device and the assistive grid so that adjustments can be made to icon locations, etc. While external websites can be programmed to take advantage of the invention, local device resident applications can also be programmed to take advantage of the invention. Optional Braille indicia also aid the blind while leaning how to use the grid 9.

The invention also allows users to take advantage of additional technology, such as RFID and/or near field communications (“NEC”). NFC tags can be used to provide inexpensive access to very local information. For purposes of discussion, the term NFC (Near Field Communication) will be used to mean NFC or RFID (Radio Frequency Identification). While this invention's primary focus is on passive RFID or NFC tags, active tags can be used as well to increase range, although such increased range is not always useful.

A passive tag is an electronic device that is able to transmit its ID when energized by an external radio wave field. Usually, such field is provided by the reader, which both powers the passive tag by transmitting a radio wave field and then receives the ID transmitted by the tag. Once the powering field is removed, the tag loses power and deactivates.

By way of example, a passive RFID/NFC tag is attached to a physical location, in this case, a bus stop post. The tag is packaged such that a person can recognize it visually, or by touch. For ease of discussion, the term “Geotag” will be used.

A Geotag consists of a i) passive or active NFC or RFID tag containing a unique ID, ii) encapsulated in a case or package and iii) equipped with a means of attaching the Geotag to a building structure such as a door, the interior of an elevator, exterior of a vending machine, a bust stop post and others.

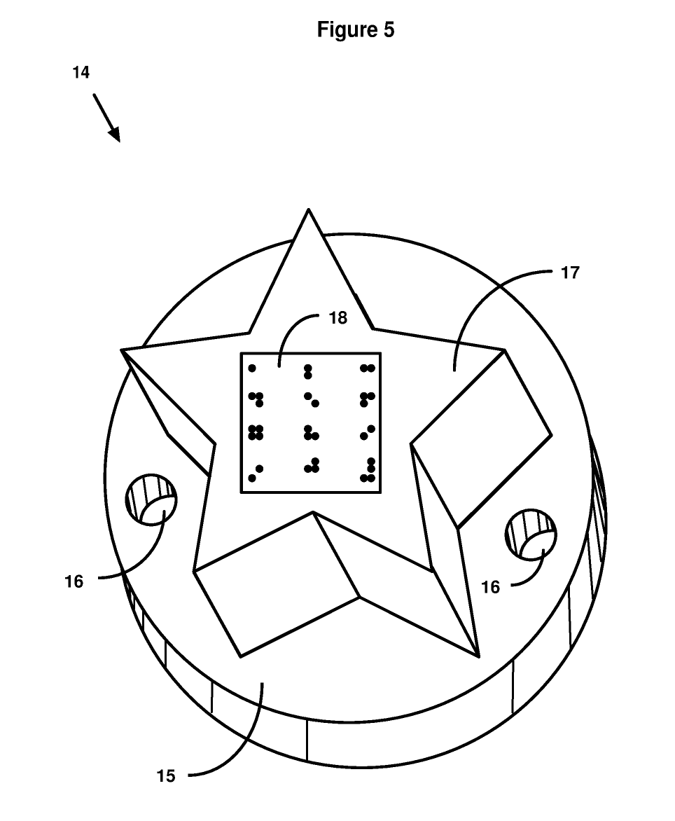

The shape and external appearance of a Geotag is important in that it allows the device to be visually recognized by normal people and recognized by palpation by those who are blind or visually handicapped. By way of example, FIGS. 5-8 illustrate a sample of shapes that may be used for Geotags such that they are readily identifiable by a blind individual as to the nature of the Geotag. In the preferred embodiment, each shape has a predetermined meaning. For example, one Geotag shape might indicate the entrance or address of a building, while another may indicate the location of a bus stop, etc. The following figures illustrate the types of distinctive shapes that would be relatively easy for blind person to use. For example, one shape may indicate an elevator. In that case, the Braille panel would be used to indicate the floor number. Likewise, another shape may indicate a bus stop with the Braille panel having information related to the route, current location, etc.

FIG. 5 illustrates a preferred embodiment of the invention in which the Geotag 14 is enclosed in a star shaped container 17. Star shaped container 17 also has an optional Braille panel 18 attached for the convenience of a blind person. The Braille panel 18 may contain any suitable message, written in Braille, that describes the purpose of that Geotag 14. The star shaped container 17 as secured to a support structure 15 that has optional apertures 16 for use by screws, nails, etc., when mounting the Geotag 14 to a structure. Of course, any other suitable method of attaching a Geotag 14, such as adhesives or cement can also be used. The shape of the Geotag 14 is useful in that a blind person instantly knows what type of Geo tag 14 that he is in contact with. In this example, the unique star shape might indicate the address of a building, an elevator floor, a bus stop, etc. While a single shape can be used for every type of application, use of multiple shapes can substantially improve ease-of-use by a blind individual. Of course, the use of varying shapes depends on standardization, such that specific applications, like bus stops, all use the same shape. Otherwise the benefit of multiple shapes is lost.

For ease of illustration, the support structure 15 is illustrated as a separate component in this and the following embodiments. However, those skilled in the art will recognize that the support structure 15 can easily be fabricated as an integral part of the Geotag 14. Likewise, The materials used to fabricate the Geotag 14 can be anything suitable, Such as plastics polyurethane polypropylene, Etc. The only requirement is that RFID or NFC circuits in the Geotag 14 are protected from environmental factors.

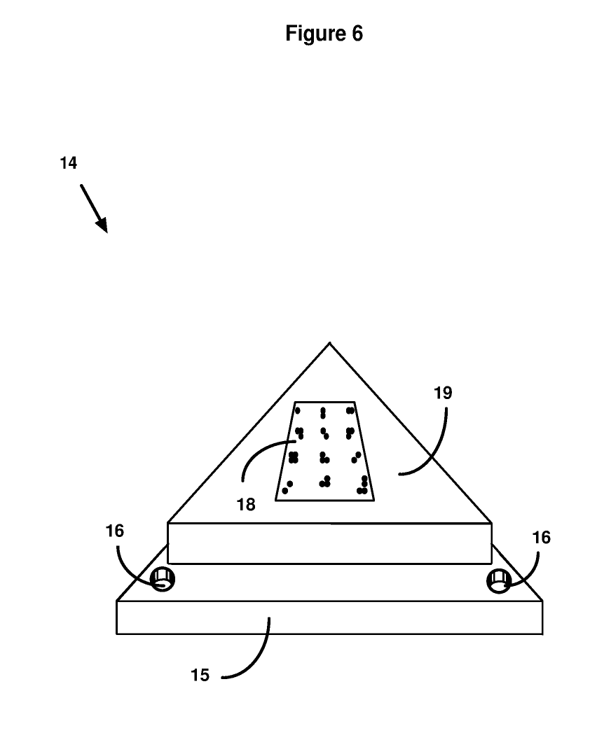

FIG. 6 illustrates an alternative preferred embodiment of the invention in which the Geotag 14 is enclosed in a triangle shaped container 19, that also has an optional Braille panel 18 attached for the convenience of a blind person. The distinctive shapes, used in this and the foregoing example, provide a blind individual Instant knowledge about the type of Geotag 14 that is being used.

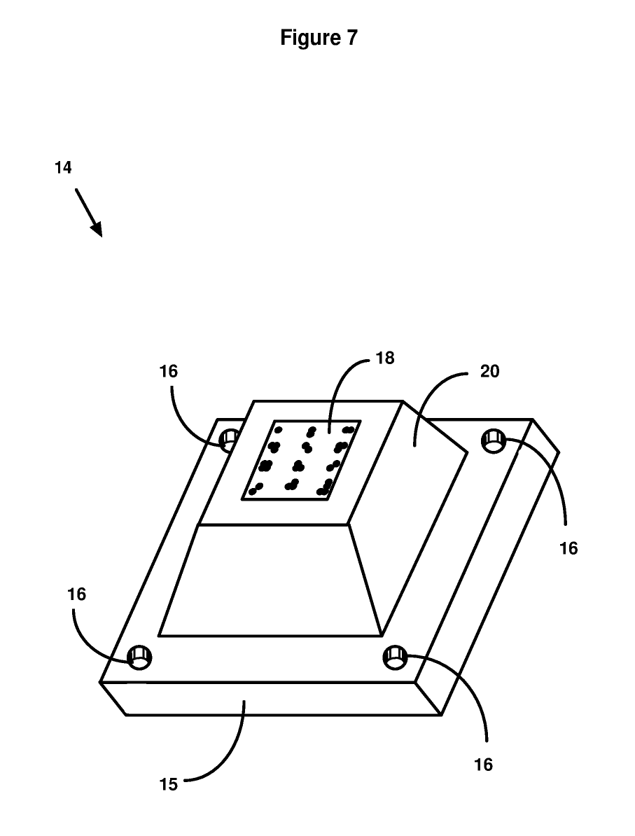

FIG. 7 illustrates another alternative preferred embodiment of the invention in which the Geotag 14 is enclosed in a pyramid shaped container 20, that, as in the other embodiments, also has an optional Braille panel 18 attached for the convenience of a blind person.

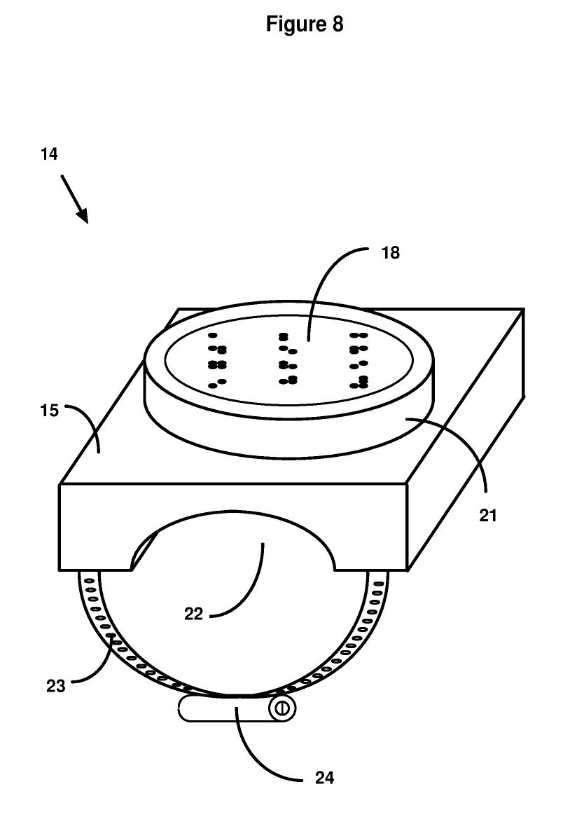

FIG. 8 illustrates yet another preferred embodiment of the invention in which the Geotag 14 is enclosed in a circular shaped container 21, and also has a Braille panel 18 attached for the convenience of a blind person. In addition, the support structure 15 of the circular shaped container 21 has a curved channel 22 that is shaped for attachment to a post or similar item. When mounted on a pole or other structure, the support structure 15 is secured by a strap 23, and an adjustable strap lock 24. Straps with adjustable strap locks are well known in the art. As can be seen by the preceding embodiments, any arbitrary shape can be used for a particular Geotag. Likewise, any number of shapes can be used depending on what services the Geotag 14 is intended to do. Of course, the shapes should be selected to match their function so that a blind individual understands what the Geotag 14 is for as soon as it is touched.

The locations and position at which Geotags are mounted should adhere to a standard, so they may be easily located. For example, building floors are typically printed or otherwise indicated on the frame of the elevator doors, the position of Braille markings for elevator buttons is standardized etc. There are many other examples, such as the street crossing warnings using truncated spheres (“warning dots”) at intersections, in order to facilitate pedestrian safety for the blind.

The means of attachment of a Geotag to a building structure, post, vending machine or other structure can vary, depending on the properties of the structure to which the Geotag 14 is attached. For example, the means of attachment can be an appropriate adhesive; an eye through which a screw fastener is passed, a clamp, such as may be used to attach the Geotag to a post, etc.

Preferably, a particular Geotag 14 corresponds to a particular website or a particular page of a particular website, so that when a Geotag 14 is read by a mobile device, such as a mobile telephone or tablet, the user's mobile device browser is directed to that website or a particular web page of that website, and that website or that page of the website that provides the desired local information.

One possible embodiment of a Geotag 14 is a conspicuously shaped plastic or epoxy object with a mechanically embedded and thus environmentally sealed RFID/NFC tag and a means of attachment, such as an adhesive pad, a fastener hole or a clamp. In general, the means of attachment is preferably simple and secure.

In the preferred embodiment, each Geotag 14 is registered with a central authority or “Geotag Registry” once mounted to a location. The Geotag 14 must be properly authenticated in order to prevent its misuse and its associated web page. As described further, the registration process can additionally include the GPS coordinates of the location at which the Geotag 14 is mounted, in order to improve the security of its subsequent use.

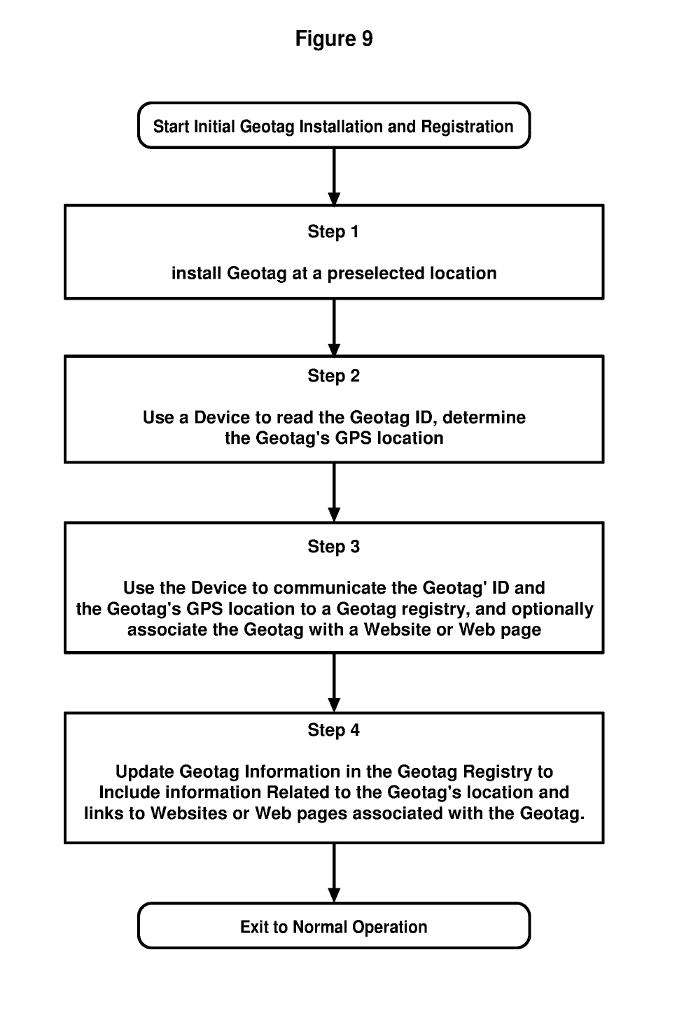

FIG. 9 is a flowchart showing the steps involved with initial installation and setup of a Geotag 14. In step 1, the Geotag 14 is physically installed at a predetermined location. The Geotag 14 can be installed in any location that would be useful for a blind individual, as described above. As discussed above, the nature of the location where the Geotag 14 is installed will determine its placement and how it is secured. For example, when a Geotag 14 is used to identify a specific building or address, it would preferably be installed next to the door of that building. Likewise, its height from the ground should preferably be at a standardized height to facilitate use by the blind. In the case of an elevator, the preferred embodiment envisions its location being above, below, or adjacent to the elevator call button. Ideally, the exact placement of the Geotag 14 should also be standardized. In the case of other locations, such as bus stops, etc., the Geotag 14 would be fastened to an appropriate location, such as a pole. Again, the height its placement should preferably be standardized for convenience to blind individuals.

In the preferred embodiment, the Geotag 14 is securely installed such that it cannot be tampered with. For enhanced security, the Geotag 14 may be structured such that forcibly removing it will cause the RFID or NFC tag to be destroyed. This discourages unauthorized relocation or theft of the Geotag 14.

In step 2, the individual installing the Geotag will use a Device, such as a smart phone, portable computer, etc., to activate the Geotag 14. When the Geotag 14 is activated by the Device, the Device reads the Geotag's ID, and also determines the geographic location of the Geotag 14. Determination of the Geotag 14 location is accomplished by using the GPS function of the Device. Today, most smart phones and portable computers have GPS circuits built-in as a standard function. The invention takes advantage of this by recording its current GPS location along with the Geotag's ID uploading to the Geotag Registry.

In step 3, the Device communicates with the Geotag Registry to upload to the Geotag Registry both the Geotag's ID, as well as the GPS coordinates detected by the Device. At this point, the Geotag Registry knows which Geotag 14 has been installed at a particular location. Optionally, the person installing the Geotag 14 can input other information to the Geotag Registry that is related to the Geotag. For example, the installer can input the building address, business occupant's name, elevator floor information, bus route number, etc.

In step 4, the Geotag Registry is further updated with additional information related to Geotag 14. The information may be addresses related to the location where the Geotag 14 is located, information related to surrounding areas, or Internet addresses such as URLs for Websites or Web pages. Once this step is completed, the passive Geotag provides its ID to the Device that activates it by illuminating it with an electromagnetic field. After the Device activates the Geotag 14 and reads the Geotag's ID, the Device then communicates with the Geotag Registry to obtain the pertinent information related to that location. Once this step is complete, the Geotags 14 are ready to be used by the public, blind or otherwise.

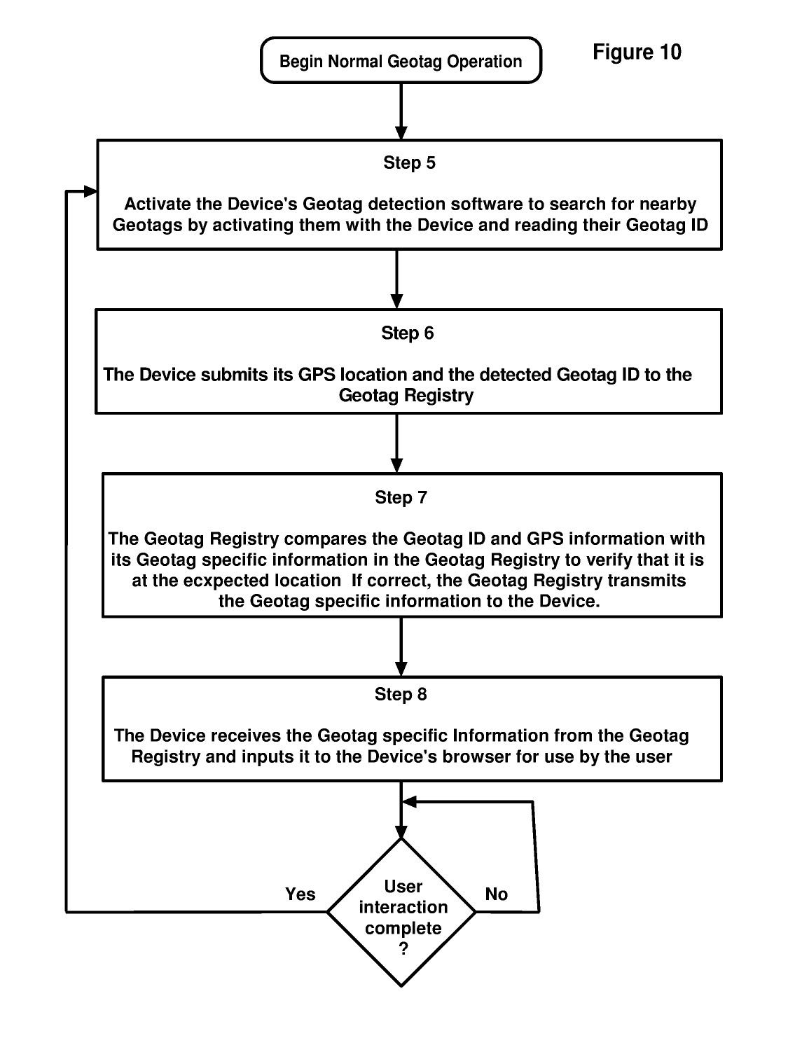

Once steps 1-4 of the installation process are complete, the Geotag is ready for normal operation. The following steps 5-8 in FIG. 10 illustrate the steps taken during normal operation of the invention.

After initial installation of a Geotag 14, it is now available for normal operation as discussed steps 5-8. In step 5, the Device actively transmits signals as it moves from place to place with the user. When the Device it's close enough to a passive Geotag 14, the Geotag 14 is activated by the electromagnetic field or other suitable signal from the Device. Once activated, the Geotag 14 communicates its Geotag ID to the Device. The Device is able to accomplish this through a software application in the Device that actively produces the electromagnetic field that enables the Geotag 14 while actively listening for a response from Geotag 14. Using this procedure, as the user moves from location to location, the Device continuously monitors for Geotag 14 IDs that are transmitted in response to the Device's electromagnetic field. When the Device is brought sufficiently close to the passive Geotag 14, the interaction of the Geotag 14 and the device begins. While the preferred embodiment of the invention uses passive RFID or NFC chips to store and transmit the Geotag 14 ID, those skilled in the art will realize that if an active (i.e., a Geotag 14 powered by an external source such as a battery) Geotag 14 is used the communication between the Device and the Geotag 14 can be initiated at greater distances. At the end of the step 5, the Geotag 14 has been detected and its ID has been communicated to the Device.

3. In step 6, the device has received the Geotag 14 ID and supplies it to the Device's software application. At this point, the Device accesses its internal GPS receiver and records its current physical location. The Device's software application then initiates communication with the Geotag Registry hand inputs the Geotag 14 ID and its GPS location to the Geotag Registry.

In step 7, to ensure that the Geotag 14 is at the correct location the Geotag Registry compares the Geotag 14 ID and its current location to the location in the Geotag Registry that was recorded when the Geotag 14 was installed in step 3. If the location is correct, the Geotag Registry then transmits Geotag specific information to the Device that was stored in the Geotag Registry at step 4 of the installation process. The Geotag specific information is any information that is pertinent to a particular Geotag 14. For example, it can be the address of a building, an elevator door with a Geotag 14 that identifies the floor where the elevator door is located.

In step 8, the Geotag information received from the Geotag Registry is input to the Device's browser so that it is accessible by the user. The device information may contain static information related to the location of the Geotag 14, or may also contain dynamic information related to a location that will be obtained from a separate website or webpage. An example of this would be a Geotag 14 located at a bus stop. The information provided by the Geotag Registry would, for example, include a URL to a website that an application in the Device would use to access the website and obtain information regarding the timing of the next bus, its routes, etc. In the preferred embodiment, information such as URL addresses would be divided during the initial installation process at step 3. The advantage to a blind individual is that the Individual would not only have current schedules, etc., but preferably also have the ability to contact the bus driver via the Device to inform the driver that a blind individual was waiting for the bus.

In the preferred embodiment, the Device's browser monitors the user's interaction with the browser so long as the user is actively engaged with the browser. When a person swipes the Geotag 14 with his mobile device (e.g. a phone equipped with an integral NFC reader or an externally connected NFC reader device, causing the Geotag 14 to be activated). This allows the mobile device to receive the Geotag's ID. This ID can now be used by the software contained in the mobile device to access a website, via the mobile device's resident browser, that corresponds to this particular bus stop. The website, in turn, can now provide the user local information corresponding to this particular bus stop—for example, the route numbers which stop at this bus stop, the time of arrival of the next bus and its route number, etc. In addition, if the interaction with the website or web page involves interaction with a device or system such as an elevator, traffic light, metro transportation system, etc., then the accessed website or webpage interactively communicates with such device or system. As a further example of how the Geotag 14 may be used, one such Device application would allow an individual to detect a Geotag 14 that is mounted on a vending machine, to then use the Device's browser to access a website linked to the vending machine and electronically purchase goods from the vending machine via the Internet, and even electronically pay for the goods via the Internet.

The above examples summarize the essence of this embodiment. Important elements include: a) Passive RFID/NFC Geotags permanently attached to physical locations; b) A mobile device capable of reading RFID/NFC Geotags and having a browser capable of accessing websites providing local information relevant to the particular Geotag, and; c) A system of associating the Geotag's id with an address of a website that provides the above local information to the user via the Device's browser.

In the foregoing example, “local information” is limited in scope and is highly relevant to a location within a very limited radius of a specific location. Examples of such “locations” and the associated “local information” are:

1. Static information, such as a buildings address, or
2. Dynamic information, such as time of day, next bus number scheduled to arrive, the current floor an elevator is on, etc., or
3. Interactive information, for example, user interaction with a website corresponding to a particular bus stop to notify the driver that that the bus should stop at a particular location

The table below offers a number of examples of local information and its types:

| Location | Local Information |
|---|---|
| Office building | Building directory (static or dynamic) |
| entry | Emergency locations and services (static) |
| | Alert (e.g. ring doorbell of) a selected tenant. |
| Elevator | Which floors the elevator services (static) |
| | Current elevator location/direction e.g. 12th |
| | floor/UP (dynamic) |
| | User enters floor number (interactive) |
| Museum | Description of displayed object (static) |
| | Narrative (static) |
| Vending machine | Items vended and respective prices (static) |
| | User places order (interactive) |
| | Mobile Payment (interactive) |
| Bus Stop | Route information (static) |
| | Approximate wait time (dynamic) |
| | Payment capability (interactive) |
| On public | Bus/train/line description (static or dynamic) |
| transportation | Destination/direction (dynamic) |
| | Next stop (dynamic) |
| | Payment capability (interactive) |
| Street signs | Location (static) |
| Traffic light | Location (static) |
| signs | Light state, time to yellow or “Don't Walk” (dynamic) |
| | Request to cross (interactive) |
| | Remaining duration of green/safe light (dynamic) |
| | Request for assistance |
| Parking Meter | Remaining time for payer (static) |
| | Payment (interactive) |
| Automatic Teller | Check balance (dynamic) |
| Machine | Login, Retrieve cash, Transfer funds between |
| | accounts (interactive) |
| Diagnostic port | Car/device/etc. status, error codes (dynamic) |
| in car, appliance, | Access to instruction, service manuals (static) |
| etc. | Changing device settings (interactive) |

NFC and/or RFID technology provides several advantages, including:

1. Providing a convenient means of rapidly gaining access to local information. For example, the convenience of interacting with a Geotag-equipped bus stop or tapping a Geotag to hear a narrative about a particular exhibit in a museum

2. Allowing devices, such as appliances, parking meters, etc. to have an equivalent of a user interface, without increasing the cost of the device with the cost of a user interface, which frequently involves displays, pushbuttons etc., especially if the device needs to be weatherproof.

3. In addition, the cost of a Geotag is exceptionally low. In quantities, RFID/NFC tags can be added to any number of devices at a very nominal cost per device.

4. Geotags are especially valuable to those who are blind or visually handicapped. Geotags can be easily deployed in building interiors or exteriors, elevators, street crossing, public transportation stops, on vending machines and in a vast number of other locations where local information is needed but not generally available to the visually handicapped.

Consider the benefit of installing Geotags in each of an office building's elevators, allowing the blind to use their mobile devices to select their destination floor and to know when they arrive there. Consider also, the benefit of installing Geotags on buses, in order to allow blind people not only to confirm that they are boarding the correct bus, to select their destination stop, track the bus' progress and be informed when they arrive to their destination. Further, Geotag-based mapping of interior spaces, allows blind users to determine their location in a building, Geotag-equipped vending and automatic teller machines and many devices allow blind users to more effectively use those devices.

The preferred embodiment of the invention provides for a level of security to prevent misuse of the invention, such as (i) unauthorized relocation of a Geotag 14 to a different location after it's location and function has been registered with the registry service, (ii) interjection of a false registry service that can provide incorrect website or webpage information to the requesting mobile device, or (iii) tampering with the Geotag itself.

To address these security concerns, the invention provides the following security mechanisms:

1. Upon the installation of each new Geotag, it's ID and the corresponding website or web page information must be registered with a registry service in order for the latter to service ID lookup requests. During this same process, the Geotag's GPS coordinates are registered as well. Subsequently, in normal operation occurring thereafter, upon reading the Geotag's id, the mobile application sends the ID along with the GPS coordinates of the mobile device itself, as provided by the mobile device's GPS mechanism, to the registry service. Upon receiving the request from the mobile device, the registry compares the provided GPS coordinates with the coordinates of the Geotag, as stored in it's database, validating the request if such coordinates are within a reasonable and expected distance of each other. Otherwise, an appropriate error is returned to the requesting device.

2. The registry is preferably configured with an SSL (Secure Sockets Layer) or TLS (Transport Layer Security) certificate that authenticates the registry service to the requesting mobile device application, similarly to a bank website SSL/TLS certificate verifying its authenticity. In addition, the presence of the SSL/TLS certificate on the registry service website allows the request/response communication between the mobile app and the registry service to be encrypted, preventing man-in-the-middle attacks. The security measures described here also protect the initial Geotag registration process.

3. The Geotag can also include a means for rendering it inoperative when removed after the initial installation or when tampered with by structuring it such that, if a Geotag is opened or removed, it will be damaged and become inoperable. This security feature, if used, prevents misuse of the Geotag.

Another alternative embodiment of the invention additionally discloses “announcement” Geotags. The operation of these is similar to that of other Geotags except that when its ID is received by the Device, the registry service is queried and the Device's browser accesses the website in the usual way, it allows the associated website to stream an audio announcement message such as “You are now on track 6. Train 475 bound for Geneva leaves at 3 PM” or “This elevator services floors 1 through 20”.

While generally useful to the overall population, this invention is especially helpful to those who are blind or visually handicapped. In order for such usefulness to be maximized, the website or web pages accessed via the mechanism described herein must provide audio information and display/position their interactive buttons in a well organized and ideally standardized way, in order to maximize their usability by the blind. The invention provides an immediate source of information through its particular shape. One shape may indicate a building entrance, another shape may indicate an elevator door, etc. In this manner, a blind individual will immediately have information based solely on the shape without any additional input. A second advantage provided by the invention is that it may contain an optional Braille panel that provides a more extended set of information, Such is the name of the company occupying the building, the floor number that the elevator door is on, etc. A third advantage of the invention is that it contains electronic RFID/NFC chip with a unique electronic ID. A user having a common smart device, such a smart phone, can use the device to read the electronic ID and then communicate with a remote Internet site to obtain a wide variety of information about that location, and in addition, to interact with other services and/or devices from the smart device based on information obtained from the Geotag.

While specific embodiments have been discussed to illustrate the invention, it will be understood by those skilled in the art that variations in the embodiments can be made without departing from the spirit of the invention. The types of materials used can vary, the method of attachment can vary, etc. Therefore, the invention shall be limited solely to the scope of the claims.

I claim:

1. A Geotag system for providing information to an individual, comprising:
at least one Geotag having a unique predetermined shape and attached to a fixed predetermined location;
the Geotag further enclosing, and shielding from the environment, an RFID or NFC tag that contains at least an electronic ID;
the RFID or NFC tag is activated when an external device having an electronic field output sufficiently strong to activate the RFID or NFC tag such that communication is established between the Geotag and the external device;
the Geotag, after communication is established, transmits information to the external device related to the Geotag's specific location or function; and
the information transmitted to the external device is then output by the external device as text and/or audio.

2. A system, as in claim 1, further comprising:
a plurality of Geotags, each Geotag having a predetermined shape that represents the type of information the Geotag provides.

3. A system, as in claim 1, wherein:
the predetermined shape is related to a specific location, address, business type and/or name, floor level, local attraction, announcements, and/or third party devices.

4. A system, as in claim 1, wherein:
the predetermined Geotag shapes are standardized such that they are easily recognizable to the Blind as a Geotag.

5. A system, as in claim 1, further comprising:
Braille indicia on the outer surface of the Geotag indicating that the device is a Geotag, and/or having information related to that Geotag or Geotag type.

6. A system, as in claim 3, wherein:
the information provided by the Geotag to the device is static information related to its location, and is the output to the external device, including a building address, information identifying a street intersection, a URL, IP address or another identifier that can be used by the device to access a website, web page or a web application.

7. A system, as in claim 3, wherein:
the information provided by the Geotag to the device is static information which is a unique Geotag ID.

8. A system, as in claim 7, wherein:
the external device uses the Geotag ID to automatically direct the user to an internet link address to access a website, web page or a web application to retrieve dynamic information related to the location, for example time dependent information including public transportation schedules and expected transportation vehicle arrival times, routing information related to the next and subsequent public transportation vehicles.

9. A system, as in claim 7, further including:
the external device uses the internet link address to access a website, web page or a web application to retrieve dynamic information related to the location, for example current status of a traffic light or floor number that an elevator is currently on.

10. A system, as in claim 7, wherein:
the external device uses the internet link address to access a website, web page or a web application that allows the user to interact with the location corresponding Geotag, for example to request a specific floor while in an elevator, to request a green crossing signal at a traffic light, or to request that a bus stop at the current bus stop.

11. A system, as in claim 1, further comprising:
an RFID/NFC reader, attached to the external device.

12. A Geotag system for providing information related to a location or function, comprising:
a central online authority having a Geotag registry that stores information related to registered Geotags in the Geotag system;
the Geotag registry further containing data related to Geotag IDs and Internet links corresponding to websites, web pages or web applications that contain or provide static or dynamic information regarding the locations of the respective Geotags.

13. A system, as in claim 12, further comprising:
an SSL/TLS certificate authenticating the Geotag registry to the external device making a request to the Geotag registry.

14. A system, as in claim 12, wherein:
encryption of the Internet traffic between the external device and the Geotag Registry via the SSL/TLS certificate configured at the Geotag registry.

15. A system, as in claim 12, wherein:
the central online authority registers new Geotags and their corresponding Internet links to associated websites, web pages or web applications.

16. A system, as in claim 12, wherein:
the central online authority registers the GPS coordinates of new Geotags.

17. A Geotag system, as in claim 12, wherein:
the external device inputs the Geotag ID from the Geotag, and outputs a request to the Geotag registry;
the Geotag registry, in response to the request from the external device, outputs internet link address information to the website, web page or web application associated with the specific Geotag to the external device.

18. A system, as in claim 17, wherein:
the external device outputs the GPS coordinates of the Geotag in addition to the Geotag ID to the Geotag registry;
the Geotag registry compares the GPS coordinates by the Geotag registry to the GPS coordinates stored in the Geotag Registry;
the Geotag registry outputs an error notification to the external device if the submitted and stored GPS coordinates do not match within a predetermined error bound.

19. A system, as in claim 17, wherein:
the Internet website accessed by the external device via the Internet link address provided by the Geotag to the external device provides time dependent information including public transportation schedules and expected transportation vehicle arrival times, routing information related to the next and subsequent public transportation vehicles.

20. A system, as in claim 19, wherein:
the Internet website accessed by the external device has communications capability that allows a user to interactively communicate with the transportation vehicle.
